(19) United States
(12) Patent Application Publication
(10) Pub. No.: US 2015/0264864 A1
(43) Pub. Date: Sep. 24, 2015

(54) MOG SENSING SYSTEM FOR A RESIDUE SPREADER

(71) Applicant: Deere & Company, Moline, IL (US)

(72) Inventors: MATTHEW G. BRANCH, VIOLA, IL (US); ANDRZEJ KOZICKI, MILAN, IL (US)

(21) Appl. No.: 14/220,608

(22) Filed: Mar. 20, 2014

(51) Int. Cl. A01D 41/12; A01F 12/30

(52) U.S. Cl. CPC A01D 41/1243; A01F 12/30

(57) ABSTRACT

A MOG sensing system for an agricultural vehicle (100) comprises a first ultrasonic sensor (204) configured to be mounted on the agricultural vehicle (100); a second ultrasonic sensor (206) configured to be mounted on the agricultural vehicle (100); an ECU (302) coupled to the first ultrasonic sensor (204) and the second ultrasonic sensor (206); wherein the ECU (302) is configured to combine signals from the first ultrasonic sensor (204) and from the second ultrasonic sensor (206) and to determine a MOG distribution of MOG ejected from the agricultural vehicle (100) based upon the combined signals.

### FIELD OF THE INVENTION

The invention relates to agricultural vehicles with residue spreaders. More particularly the invention relates to sensing systems for determining a distribution of residue from the residue spreader.

### BACKGROUND

Agricultural vehicles such as agricultural harvesters sever crop plants from the ground, gather the severed crop plants together, separate the grain in the crop plants from the remainder of the plant (“material other than grain” or MOG), chop the MOG, and then spread the MOG over the ground to evenly cover the ground from which the MOG was gathered.

An agricultural harvester harvests crop using a harvesting head supported on the front of the vehicle. The harvesting head may be 10 or 15 m wide. The chopped MOG typically leaves the agricultural harvester through a 1 to 2 m wide channel at the rear of the agricultural harvester. Immediately after it leaves the chute, it must be spread considerably to cover the 10 or 15 m wide swathe of ground harvested by the harvesting head.

This even spreading of the MOG is not easy. The MOG may be light or heavy. It may be blown easily by the wind or fall quickly to the ground. If the wind is blowing strongly across the path of the agricultural harvester, the entire swath of MOG may be shifted to the left or to the right. This will leave uncovered some regions of the field due to poor distribution of the MOG.

In order to improve the distribution of MOG, sensing means have been suggested to sense the distribution of MOG at the rear the machine. With this knowledge, the operator can manually (or automatically) adjust the angle of the steering members that steer the MOG leaving the agricultural harvester.

One of these sensing means is a digital camera disposed at the rear of the agricultural harvester to picture the swath of MOG as it leaves the agricultural harvester and spreads out to cover the ground. The operator can look at this camera image in the operator cabin and determine whether the MOG is being properly steered. With this information, the operator can adjust (either manually or automatically) the steering members.

Another of these sensing means is a wind vane and/or wind velocity sensor. Typically these sensors are disposed on top of the agricultural harvester. The sensor data provides the operator with an indirect measurement of how well his MOG is being spread. With this information, the operator can adjust (either manually or automatically) the steering members.

These sensing means are less than ideal.

It is often difficult to tell what is in an image. This can lead an operator to over- or under-correct when he adjusts the MOG steering members.

Furthermore, a strong wind may have a large effect in steering the MOG leaving the agricultural harvester in certain crops and little or no effect in others. Thus, the wind speed and wind direction alone may not be enough to determine the actual distribution of MOG behind the agricultural harvester.

What is needed, therefore, is a better way of determining the lateral distribution of the MOG behind the agricultural harvester. It is an object of this invention to provide such a system.

### SUMMARY OF THE INVENTION

In accordance with a first aspect of the invention, a MOG sensing system for a residue spreader of an agricultural harvester comprises: a first ultrasonic sensor configured to be mounted on the agricultural harvester; a second ultrasonic sensor configured to be mounted on the agricultural harvester; an ECU coupled to the first ultrasonic sensor and the second ultrasonic sensor; wherein the ECU is configured to combine signals from the first ultrasonic sensor and from the second ultrasonic sensor and to determine a MOG distribution of MOG ejected from the agricultural harvester based upon the combined signals.

The first ultrasonic sensor may be directed toward a stream of MOG ejected from the agricultural harvester, and wherein the second ultrasonic sensor is also directed toward the stream of MOG ejected from the agricultural harvester.

The first ultrasonic sensor and the second ultrasonic sensor may be configured to produce a signal indicative of the amount of MOG ejected from the agricultural harvester.

The ECU may be configured to determine the relative magnitude of signals received from the first ultrasonic sensor and from the second ultrasonic sensor.

The ECU may be configured to control a direction of ejection of MOG from the agricultural harvester based upon a combination of the signals from the first ultrasonic sensor and the second ultrasonic sensor.

Among sensing system may further comprise an actuator and at least one steering member coupled to the actuator, wherein the ECU 302 is configured to control the actuator to turn the at least one steering member in a direction to change a difference in signal magnitude of signals by the first ultrasonic sensor and the second ultrasonic sensor.

The at least one steering member may comprise a plurality of steering members that are simultaneously positioned by the actuator.

### BRIEF DESCRIPTION OF THE DRAWINGS

FIG. 1 is a left side view of an agricultural harvester in accordance with the present invention.

FIG. 2 is a cross-sectional view of agricultural harvester of FIG. 1 taken at section line 2-2 in FIG. 1.

FIG. 3 is a schematic circuit diagram of the MOG sensing system.

FIG. 4 is a flowchart of the functions performed by the MOG sensing system of FIG. 3.

### DETAILED DESCRIPTION

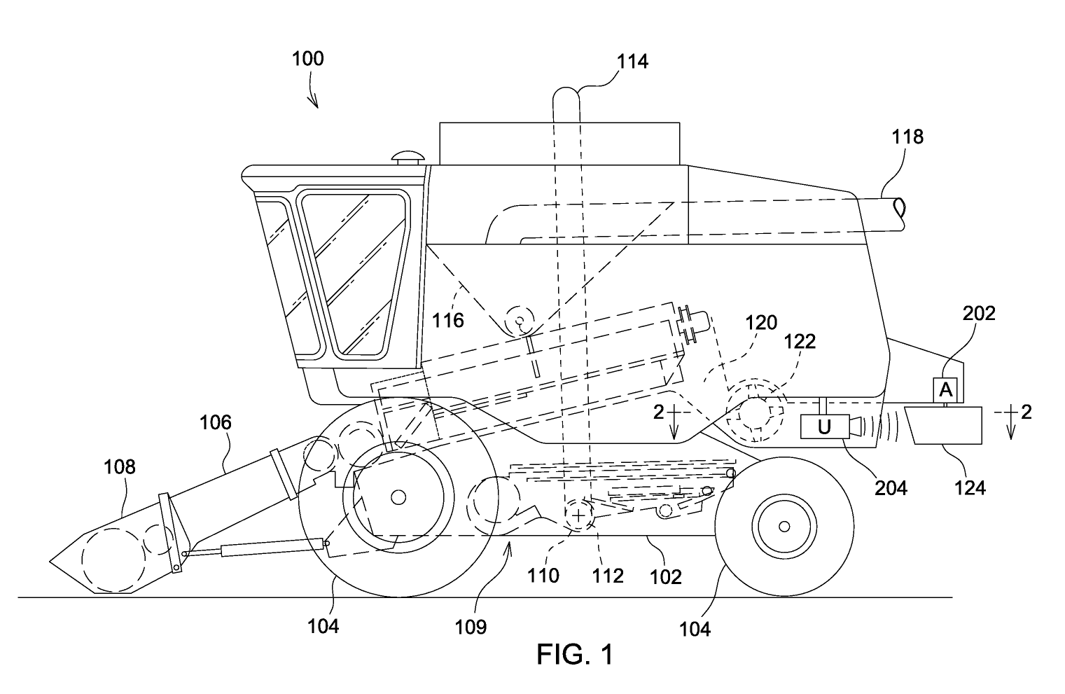

Referring to FIG. 1, an agricultural harvester 100, here shown as a combine, comprises a chassis 102 that is supported on wheels 104 to be driven over the ground and harvest crops. A feederhouse 106 extends from the front of the agricultural harvester 100. An agricultural harvesting head 108 is supported on the front of the feederhouse 106. When the agricultural harvester 100 operates, it carries the feederhouse 106 through the field harvesting crops. The feederhouse 106 conveys crop gathered by the agricultural harvesting head 108 rearward and into the body of the agricultural harvester 100. Inside the agricultural harvester 100, the crop is threshed, separated, and cleaned by mechanisms 109. The now-clean grain falls downward into an auger trough 110. An auger 112 disposed in the auger trough 110 carries the material to the right side of the agricultural harvester 100 and deposits the grain in the lower end of a grain elevator 114. The grain lifted by the vertical grain elevator 114 is carried upward until it reaches the upper exit of the grain elevator 114. The grain is then released from the grain elevator 114 and falls into a grain tank 116.

The agricultural harvester 100 is periodically unloaded by pivoting an unloading auger 118 away from the side of the agricultural harvester 100, and conveying the grain into a grain cart or grain wagon (not shown) traveling alongside the agricultural harvester 100. After the MOG is separated from the grain, it falls into a conduit 120 which steers the MOG rearward and into a chopper 122. The chopper chops and accelerates the MOG, and blows the chopped MOG rearward into several MOG steering members 124 (here shown as steering vanes). The steering members spread the MOG laterally (e.g. to the left and to the right) as it is ejected from the rear of the agricultural harvester 100. The MOG then falls on the ground and covers the swath just harvested by the agricultural harvesting head 108.

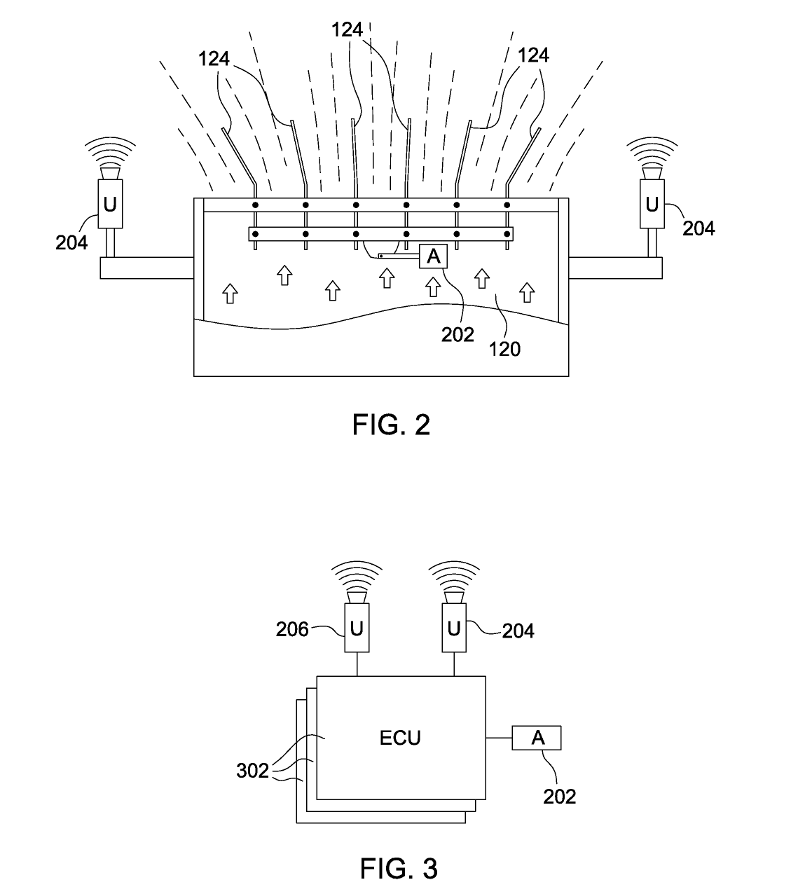

Referring to FIG. 2, steering members 124 are supported for pivoting movement from the rear of the agricultural harvester 100. The steering members 124 can be pivoted to the left and to the right to selectively steer the MOG exiting the agricultural harvester 100. An actuator 202 is coupled to the steering members 124 to steer them. The actuator 202 may be, for example, a rotary actuator or linear actuator. It may be, for example, an electric actuator or a hydraulic actuator.

A first ultrasonic sensor 204 is coupled to the left rear of the agricultural harvester 100 in a position to view the MOG leaving the left rear of the agricultural harvester 100. A second ultrasonic sensor 206 is coupled to the right rear of the agricultural harvester 100 in a position to view the MOG leaving the right rear of the agricultural harvester 100.

The first ultrasonic sensor 204 is positioned to the left of the steering members 124. The second ultrasonic sensor 206 is positioned to the right of the steering members 124.

Referring to FIG. 3, a MOG sensing system 300 comprises the first ultrasonic sensor 204 and the second ultrasonic sensor 206 coupled to an electronic control unit (ECU) 302. The ECU 302 comprises an ALU and a memory circuit. The memory circuit includes digital instructions that are executed by the ALU and control the ECU 302. The ECU 302 also comprises signal conditioning circuits configured to receive the signals from the first ultrasonic sensor 204 and the second ultrasonic sensor 206 and condition the signals. The ECU 302 also comprises a driver circuit configured to convert commands from the ALU into a form and at a level that can be applied to the actuator 202 sufficient to move the actuator 202 and the steering members 124.

In the embodiment of FIG. 3, an ECU 302 is shown. In other arrangements, a plurality of ECUs 302 can be used in place of the single ECU 302. The ECUs comprising this plurality of ECUs 302 can be connected to one another in a communications network (e.g. in a CAN bus arrangement). Further, any of the sensors described herein can be connected to any of the plurality of ECUs 302. Further, all the ECUs 302 can be connected in the communication network to share any sensor or actuator information with any other ECU 302. Further, each ECU 302 of the plurality of ECUs can be programmed to provide one, more than one, or all of the ECU functions described herein.

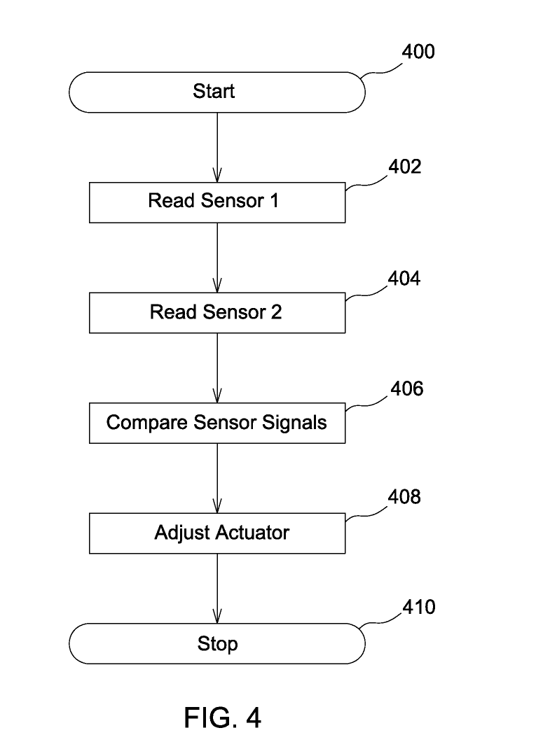

FIG. 4 illustrates the steps performed by the MOG sensing system 300. These steps are stored in the memory circuit of the ECU 302 as a series of programmed instructions. In the case of a multiple ECUs system, some of these steps can be performed by one ECU 302 and others of these steps can be performed by another ECU 302.

In step 400, the process starts.

In step 402, the ECU 302 reads a signal from the first ultrasonic sensor 204.

In operation, the first ultrasonic sensor 204 emits an ultrasonic signal. This ultrasonic signal is directed toward and travels outward into the cloud of MOG flying through the air on the left side of the agricultural harvester 100. A portion of the ultrasonic signal is reflected back to the first ultrasonic sensor 204 by the cloud of MOG. The magnitude of this portion depends upon the thickness and/or density of the cloud of MOG. The greater the thickness and/or density of the cloud of MOG, the greater the magnitude of the reflected portion. First ultrasonic sensor 204 is configured to receive this reflected portion and convert it into a computer readable form. Hence, the signal produced by the first ultrasonic sensor and transmitted to the ECU 302 is indicative of the thickness and/or density of the cloud of MOG on the left side of the agricultural harvester 100.

In step 404, the ECU 302 reads a signal from the second ultrasonic sensor 206. The second ultrasonic sensor 206 is constructed the same as the first ultrasonic sensor 204, and therefore produces a signal that it transmits to the ECU 302 that is indicative of the thickness and/or density of the cloud of MOG on the right side of the agricultural harvester 100.

If the MOG leaving the agricultural harvester 100 is being spread evenly across the ground behind the agricultural harvester 100, the signal transmitted by the first ultrasonic sensor 204 to the ECU 302 and the signal transmitted by the second ultrasonic sensor 206 to the ECU 302 will be the same.

If more of the MOG is being spread on the left side of the agricultural harvester 100, then the signal transmitted by the first ultrasonic sensor 204 to the ECU 302 will be greater than the signal transmitted by the second ultrasonic sensor 206 to the ECU 302.

Likewise, if more of the MOG is being spread on the right side of the agricultural harvester 100, then the signal transmitted by the first ultrasonic sensor 204 to the ECU 302 will be smaller than the signal transmitted by the second ultrasonic sensor 206 to the ECU 302.

In step 406, the ECU 302 compares the signals from the first ultrasonic sensor 204 in the second ultrasonic sensor 206 and determines, based upon this comparison, whether the MOG is spread more to the right or more to the left behind the agricultural harvester 100.

In step 408, the ECU 302 calculates a signal to be applied to the actuator 202 based upon the comparison performed in step 406. The signal is calculated to direct the flow of MOG leaving the agricultural harvester 100 to spread more evenly across the swath harvested by the agricultural harvesting head 108. Thus, if the ultrasonic sensors indicate that too much MOG is going to the left, the ECU 302 signals the actuator to steer the MOG more to the right. Likewise, if the ultrasonic sensors indicate that too much MOG is going to the right, the ECU 302 signals the actuator to steer the MOG more to the left. In another arrangement, the ECU 302 calculates a signal to be applied to the actuator 202 based upon the comparison performed in step 406 to achieve an unequal distribution of the MOG on the ground.

In step 410, the process stops.

The ECU 302 is configured to automatically and repeatedly execute the process of FIG. 4 at regular intervals. The intervals (i.e. the time between each execution of the process of FIG. 4) may be from a few milliseconds to a few minutes long.

The Figures herein illustrate one embodiment of the invention. The invention is not limited to the illustrated embodiment, however. To one skilled in the art of agricultural vehicle design and operation, other embodiments of the invention are also possible.

For example, rather than the vanes shown herein, vanes can be provided on the rotors of spreading fans such as those shown in US2013263565, US2010120482, and US2014066148, (which are all incorporated herein by reference for all that they teach). In this arrangement, rather than (as illustrated herein) turning vanes to the left or the right to direct MOG flow more to the left or more to the right, the ECU 302 can be coupled to and drive the spreading fan motors to accelerate the left side spreading fan (and its vanes) and/or decelerate the right side spreading fan (and its vanes) to spread crop more to the left; or alternatively accelerate the right side spreading fan (and its vanes) and/or decelerate the left side spreading fan (and hence its vanes) to spread crop more to the right. In this example, the spreading fan motors constitute the actuator 202.

As another example, a plurality of choppers may be provided, such as the two choppers shown in US2014/0031096, which is incorporated herein by reference for all that it teaches. In this arrangement, the chopper blades function is vanes to steer and direct the crop laterally outward away from the agricultural harvester. The ECU 302 in this arrangement can be coupled to the chopper motors to vary the relative speeds of the motors and therefore the relative distribution of MOG to the left and to the right. The chopper motors in this arrangement collectively constitute the actuator 202.

As another example, multiple actuators 202 can be provided to control one or more individual vanes. In this manner, one or more vanes on one side of the agricultural harvester can be steered by the ECU 302 independently of vanes on the other side of the agricultural harvester.

As another example, the ECU 302 may be programmed to achieve an unequal distribution of MOG on the ground behind the agricultural harvester such that more MOG is distributed on one side of the agricultural harvester that is spread on the other side of the agricultural harvester. In this case, the ECU 302 would be programmed to compare the signals from the first and second ultrasonic sensors and to maintain a nonzero difference between the signals. This nonzero difference between the signals would result in more MOG being spread on one side of the agricultural harvester than is spread on the other side of the agricultural harvester.

I claim:

1. A MOG sensing system for a residue spreader of an agricultural vehicle (100) comprising:
a first ultrasonic sensor (204) configured to be mounted on the agricultural vehicle (100);
a second ultrasonic sensor (206) configured to be mounted on the agricultural vehicle (100); and
an ECU (302) coupled to the first ultrasonic sensor (204) and the second ultrasonic sensor (206);
wherein the ECU (302) is configured to combine signals from the first ultrasonic sensor (204) and from the second ultrasonic sensor (206) and to determine a MOG distribution of MOG ejected from the agricultural vehicle (100) based upon the combined signals.

2. The MOG sensing system for a residue spreader of an agricultural vehicle (100) of claim 1, wherein the first ultrasonic sensor (204) is directed toward a stream of MOG ejected from the agricultural vehicle (100), and wherein the second ultrasonic sensor (206) is also directed toward the stream of MOG ejected from the agricultural vehicle (100).

3. The MOG sensing system for a residue spreader of an agricultural vehicle (100) of claim 1, wherein the first ultrasonic sensor (204) and the second ultrasonic sensor (206) are configured to produce a signal indicative of the amount of MOG ejected from the agricultural vehicle (100).

4. The MOG sensing system for a residue spreader of an agricultural vehicle (100) of claim 1, wherein the ECU (302) is configured to determine a relative magnitude of signals received from the first ultrasonic sensor (204) and from the second ultrasonic sensor (206).

5. The MOG sensing system for a residue spreader of an agricultural vehicle (100) of claim 4, wherein the ECU (302) is configured to control a direction of ejection of MOG from the agricultural vehicle (100) based upon a combination of the signals from the first ultrasonic sensor (204) and the second ultrasonic sensor (206).

6. The MOG sensing system for a residue spreader of an agricultural vehicle (100) of claim 1, further comprising an actuator (202) and at least one steering member (124) coupled to the actuator, wherein the ECU 302 is configured to control the actuator (202) to turn the at least one steering member (124) in a direction to change a difference in signal magnitude of signals by the first ultrasonic sensor (204) and the second ultrasonic sensor (206).

7. The MOG sensing system for a residue spreader of an agricultural vehicle (100) of claim 6, wherein the at least one steering member (124) comprises a plurality of steering members (124) that are simultaneously positioned by the actuator (202).

8. An agricultural vehicle (100) having a MOG sensing system in accordance with claim 1.
